(19) United States
(12) Patent Application Publication
(10) Pub. No.: US 2024/0414652 A1
(43) Pub. Date: Dec. 12, 2024

(54) REPORTING CHANNEL STATE INFORMATION IN A NETWORK ENERGY SAVING MODE

(71) Applicant: Lenovo (Singapore) Pte. Ltd., New Tech Park (SG)

(72) Inventors: Ahmed Hindy, Aurora, IL (US); Vijay Nangia, Woodridge, IL (US)

(21) Appl. No.: 18/736,023

(22) Filed: Jun. 6, 2024

Related U.S. Application Data
(60) Provisional application No. 63/507,382, filed on Jun. 9, 2023.

(51) Int. Cl. H04W 52/02; H04B 7/06; H04W 72/1273; H04W 72/231

(52) U.S. Cl. CPC H04W 52/0235; H04B 7/0626; H04B 7/0639; H04W 72/1273; H04W 72/231

(57) ABSTRACT

Apparatuses, methods, and systems are disclosed for wireless communication, including reporting channel state information (CSI) in a network energy saving mode. One method includes receiving a first indication of a network energy saving mode. The method includes receiving a second indication of a CSI reporting setting associated with multiple sub-configurations corresponding to multiple power control offset values based at least in part on receiving the first indication, wherein the CSI report setting is associated with a plurality of CSI report quantities, and wherein a first group of values of the plurality of the CSI report quantities is common for a subset of the multiple sub-configurations. The method includes transmitting a CSI report comprising the first group of values of the plurality of the CSI report quantities and the second group of values of the plurality of the CSI report quantities.

### FIELD

The subject matter disclosed herein relates generally to wireless communications and more particularly relates to reporting channel state information (CSI) in a network energy saving mode.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications systems may also support CSI reporting. In some cases, CSI reporting may be configured for improved reporting.

### BRIEF SUMMARY

Methods for reporting CSI in a network energy saving mode are disclosed. Apparatuses and systems also perform the functions of the methods. One embodiment of a method includes receiving, from a network entity, a first indication of a network energy saving mode. In some embodiments, the method includes receiving, from the network entity, a second indication of a CSI reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations. In certain embodiments, the method includes transmitting a CSI report comprising the first group of values of the plurality of the CSI report quantities and the second group of values of the plurality of the CSI report quantities.

One apparatus for reporting CSI in a network energy saving mode includes a memory. In some embodiments, the apparatus includes a processor coupled to the memory and configured to cause the apparatus to: receive, from a network entity, a first indication of a network energy saving mode; receive, from the network entity, a second indication of a CSI reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations; and transmit a CSI report comprising the first group of values of the plurality of the CSI report quantities and the second group of values of the plurality of the CSI report quantities.

Another embodiment of a method for reporting CSI in a network energy saving mode includes transmitting, to a UE, a first indication of a network energy saving mode. In some embodiments, the method includes transmitting, to the UE, a second indication of a CSI reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations. In certain embodiments, the method includes receiving a CSI report comprising the first group of values of the plurality of the CSI report quantities and the second group of values of the plurality of the CSI report quantities.

Another apparatus for reporting CSI in a network energy saving mode includes a memory. In some embodiments, the apparatus includes a processor coupled to the memory and configured to cause the apparatus to: transmit, to a UE, a first indication of a network energy saving mode; transmit, to the UE, a second indication of a CSI reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations; and receive a CSI report comprising the first group of values of the plurality of the CSI report quantities and the second group of values of the plurality of the CSI report quantities.

### BRIEF DESCRIPTION OF THE DRAWINGS

FIG. 1 illustrates an example of a wireless communications system that supports reporting CSI in a network energy saving mode in accordance with aspects of the present disclosure;

FIG. 2 illustrates an example of an apparatus that supports reporting CSI in a network energy saving mode in accordance with aspects of the present disclosure;

FIG. 3 illustrates an example of an apparatus that supports reporting CSI in a network energy saving mode in accordance with aspects of the present disclosure;

FIG. 4 illustrates an example of a flowchart of an aperiodic trigger state defining a list of CSI report settings in accordance with aspects of the present disclosure;

FIG. 5 illustrates an example of code in which an aperiodic trigger state indicates a resource sent and quasi-co-location (QCL) information in accordance with aspects of the present disclosure;

FIG. 6A illustrates an example of code in which a radio resource control (RRC) configuration includes a non-zero power (NZP) CSI reference signal (RS) (CSI-RS) (NZP-CSI-RS) resource in accordance with aspects of the present disclosure;

FIG. 6B illustrates an example of code in which an RRC configuration includes a CSI interference measurement (IM) (CSI-IM) resource in accordance with aspects of the present disclosure;

FIG. 7 illustrates an example of a system for partial CSI omission for physical uplink shared channel (PUSCH)-based CSI in accordance with aspects of the present disclosure;

FIG. 8 illustrates a flow chart of a method that supports reporting CSI in a network energy saving mode in accordance with aspects of the present disclosure; and

FIG. 9 illustrates a flow chart of another method that supports reporting CSI in a network energy saving mode in accordance with aspects of the present disclosure.

### DETAILED DESCRIPTION

A wireless communications system may include multiple communication devices, including network communication devices and user communication devices, which may support wireless communication in the wireless communications system. For example, the network communication devices and the user communication devices may support one or multiple radio access technologies including 4G, 5G, and radio access technologies beyond 5G (e.g., 6G). The wireless communications system may also support sidelink (SL) communications between multiple user communication devices (e.g., UEs). Examples of SL communications may include, but is not limited to, device-to-device (D2D) communications, vehicle-based communications, such as vehicle-to-vehicle (V2V) communications, vehicle-to-everything (V2X) communications, etc. As demand for communication high efficiency, high reliability, and low latency increases, it may be desirable for the wireless communications system, including the network communication devices and the user communication devices to support improvements to resource management for SL communications.

Various aspects of the present disclosure relate to configuring CSI reporting for a UE in a network energy saving mode. The network energy saving mode may be a specific mode for a UE (or another device) in which the UE applies predetermined parameters to reduce the energy consumed by the UE. The reporting may include providing the UE with multiple sets of information to enable the UE to prepare one or more CSI reports.

Aspects of the present disclosure are described in the context of a wireless communications system. Aspects of the present disclosure are further illustrated and described with reference to apparatus diagrams and flowcharts.

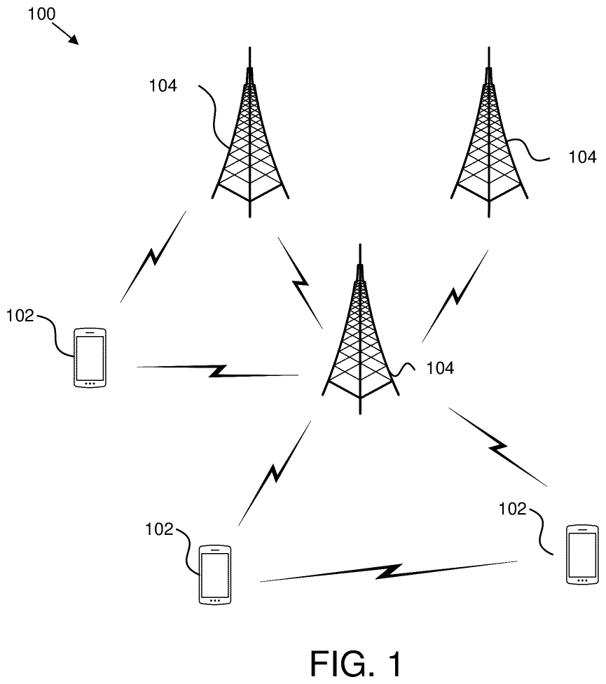

FIG. 1 illustrates an example of a wireless communications system 100 that supports reporting CSI in a network energy saving mode in accordance with aspects of the present disclosure. The wireless communication system 100 may include one or more remote units 102 and one or more network units 104. The wireless communications system 100 may support various radio access technologies. In some embodiments, the wireless communications system 100 may be a 4G network, such as a long term evolution (LTE) network or an LTE-Advanced (LTE-A) network. In some other embodiments, the wireless communications system 100 may be a 5G network, such as a new radio (NR) network. In other embodiments, the wireless communications system 100 may be a network beyond 5G. Additionally, even though a specific number of remote units 102 and network units 104 are depicted in FIG. 1, one of skill in the art will recognize that any number of remote units 102 and network units 104 may be included in the wireless communication system 100.

The one or more remote units 102 may be dispersed throughout a geographic region of the wireless communications system 100. A remote unit 102 may include or may be referred to as a UE, a computing device, such as a desktop computer, a laptop computer, a personal digital assistant (PDA), a tablet computer, a smartphone, a smart television (e.g., televisions connected to the Internet), a set-top box, a game console, a security system (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via uplink (UL) communication signals. In certain embodiments, the remote units 102 may communicate directly with other remote units 102 via SL communication.

The network units 104 may be distributed over a geographic region. In certain embodiments, a network unit 104 may also be referred to and/or may include one or more of an access point, an access terminal, a base, a base station, a location server, a core network (CN), a radio network entity, a Node-B, an eNB, a 5G node-B (e.g., gNB), a Home Node-B, a relay node, a device, a core network, an aerial server, a radio access node, an access point (AP), NR, a network entity, an access and mobility management function (AMF), a unified data management (UDM), a unified data repository (UDR), a UDM/UDR, a policy control function (PCF), a radio access network (RAN), a network slice selection function (NSSF), an operations, administration, and management (OAM), a session management function (SMF), a user plane function (UPF), an application function, an authentication server function (AUSF), security anchor functionality (SEAF), trusted non-third generation partnership project (3GPP) gateway function (TNGF), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an orthogonal frequency division multiplexing (OFDM) modulation scheme on the downlink (DL) and the remote units 102 transmit on the UL using a single-carrier frequency division multiple access (SC-FDMA) scheme or an OFDM scheme. More generally, however, the wireless communication system 100 may implement some other open or proprietary communication protocol, for example, WiMAX, institute of electrical and electronics engineers (IEEE) 802.11 variants, global system for mobile communications (GSM), general packet radio service (GPRS), universal mobile telecommunications system (UMTS), LTE variants, code division multiple access 2000 (CDMA2000), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive, from a network entity, a first indication of a network energy saving mode. In some embodiments, the remote unit 102 may receive, from the network entity, a second indication of a CSI reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations. In certain embodiments, the remote unit 102 may transmit a CSI report comprising the first group of values of the plurality of the CSI report quantities and the second group of values of the plurality of the CSI report quantities. Accordingly, the remote unit 102 may be used for reporting CSI in a network energy saving mode.

In certain embodiments, a network unit 104 may transmit, to a UE, a first indication of a network energy saving mode. In some embodiments, the network unit 104 may transmit, to the UE, a second indication of a CSI reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations. In certain embodiments, the network unit 104 may receive a CSI report comprising the first group of values of the plurality of the CSI report quantities and the second group of values of the plurality of the CSI report quantities. Accordingly, the network unit 104 may be used for reporting CSI in a network energy saving mode.

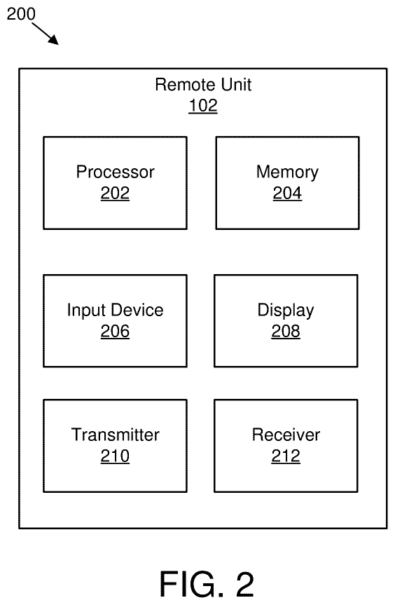

FIG. 2 illustrates an example of an apparatus 200 that supports reporting CSI in a network energy saving mode in accordance with aspects of the present disclosure. The apparatus 200 may be an example of a remote unit 102 as described herein. The remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (LCD), a light emitting diode (LED) display, an organic light emitting diode (OLED) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 is coupled to the memory 204 and configured to cause the apparatus 200 to: receive, from a network entity, a first indication of a network energy saving mode; receive, from the network entity, a second indication of a CSI reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations; and transmit a CSI report comprising the first group of values of the plurality of the CSI report quantities and the second group of values of the plurality of the CSI report quantities.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

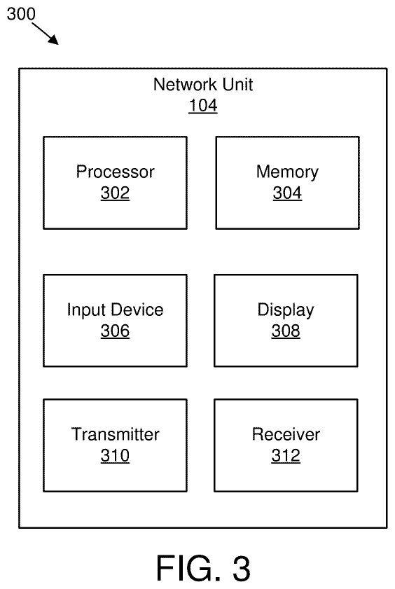

FIG. 3 illustrates an example of an apparatus that supports reporting CSI in a network energy saving mode in accordance with aspects of the present disclosure. The apparatus 300 may be an example of a network unit 104 as described herein. The network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302 is coupled to the memory 304 and configured to cause the apparatus 300 to: transmit, to a UE, a first indication of a network energy saving mode; transmit, to the UE, a second indication of a CSI reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations; and receive a CSI report comprising the first group of values of the plurality of the CSI report quantities and the second group of values of the plurality of the CSI report quantities.

It should be noted that one or more embodiments described herein may be combined into a single embodiment.

In certain embodiments, a UE may have distinct precoding matrix indicator (PMI), rank indicator (RI), channel quality indicator (CQI), and layer indicator (LI) values corresponding to different sub-configurations associated with different power control offset values. In such embodiments, CSI feedback overhead may be significantly large due to reporting all CSI report quantities for each sub-configuration separately; however, some CSI report quantities may be similar for different sub-configurations (e.g., PMI value corresponding to a subset of layers).

In some embodiments, a UE may be configured with the same PMI, RI, and LI values corresponding to different sub-configurations associated with different power control offset values, whereas each sub-configuration is associated with a distinct CQI. In such embodiments, different sub-configurations associated with the different power control offset values may correspond to different RI values leading to challenges with respect to mapping the layers of the PMI to different sub-configurations with the different number of layers for each sub-configuration.

In some embodiments, there may be different NR codebook types. In various embodiments, there may be an NR Type-II codebook.

In certain embodiments, assume a gNB is equipped with a two-dimensional (2D) antenna array with N₁, N₂ antenna ports per polarization placed horizontally and vertically and communication occurs over N₃ PMI sub-bands. A PMI subband includes a set of resource blocks, each resource block including a set of subcarriers. In such case, 2N₁N₂ CSI-RS ports may be used to enable DL channel estimation with high resolution for NR Type-II codebook. To reduce UL feedback overhead, a discrete Fourier transform (DFT)-based CSI compression of the spatial domain is applied to L dimensions per polarization, where L<N₁N₂. In the sequel, the indices of the 2L dimensions are referred as spatial domain (SD) basis indices. The magnitude and phase values of the linear combination coefficients for each sub-band are fed back to the gNB as part of the CSI report.

The 2N₁N₂×N₃ codebook per layer takes on the form W=W₁W₂, where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript T denotes a matrix transposition operation. It should be noted that O₁, O₂ oversampling factors are assumed for the 2D DFT matrix from which matrix B is drawn. Further W₁ is common across all layers. W₂ is a 2L×N₃ matrix, where the i^{th} column corresponds to the linear combination coefficients of the 2L beams in the i^{th} sub-band. Only the indices of the L selected columns of B are reported, along with the oversampling index taking on O₁O₂ values. Moreover, W₂ are independent for different layers.

In some embodiments, there may be an NR Type-II port selection codebook. For Type-II port selection codebook, only K (where K≤2N₁N₂) beamformed CSI-RS ports are used in DL transmission to reduce complexity. The K×N₃ codebook matrix per layer takes on the form:

$${W}_{l} = {W}_{1}^{PS} {W}_{2 , l} .$$

Here, W₂ follows the same structure as an NR Type-II codebook, and are layer specific. W₁^{PS} is a K×2L block-diagonal matrix with two identical diagonal blocks, i.e.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows:

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

where eᵢ^{(K)} is a standard unit vector with a 1 at the i^{th} location. Here d_{PS} is a RRC parameter which takes on the values {1,2,3,4} under the condition d_{PS}≤min (K/2, L), whereas m_{PS} takes on the values

$$\{ 0 , … , ⌈ \frac{K}{2 {d}_{PS}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0, 1, . . . , 7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] ,$$

$$[ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

In various embodiments, m_{PS} parametrizes the location of the first 1 in the first column of E, whereas d_{PS} represents the row shift corresponding to different values of m_{PS}.

In various embodiments, there may be an NR Type-I codebook. NR Type-I codebook may be a baseline codebook for NR, with a variety of configurations. The most common utility of Type-I codebook is a special case of NR Type-II codebook with L=1 for RI=1,2, wherein a phase coupling value is reported for each sub-band, i.e., W₂ is 2×N₃, with the first row equal to [1, 1, . . . , 1] and the second row equal to [e^{j2πø}^{₀}, e^{j2πø}^{_{N3-1}}]. Under specific configurations, ϕ₀=ϕ₁ . . . =ϕ, i.e., wideband reporting. For RI>2 different beams are used for each pair of layers. Obviously, NR Type-I codebook can be depicted as a low-resolution version of NR Type-II codebook with spatial beam selection per layer-pair and phase combining only. More details on NR Type-I codebook can be found in NR Type-II codebook.

Assume the gNB is equipped with a 2D antenna array with N₁, N₂ antenna ports per polarization placed horizontally and vertically and communication occurs over N₃ PMI subbands. A PMI subband includes a set of resource blocks, each resource block consisting of a set of subcarriers. In such case, 2N₁N₂N₃ CSI-RS ports are utilized to enable DL channel estimation with high resolution for NR Type-II codebook. To reduce the UL feedback overhead, a DFT-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form: w=w₁\tilde{w}_{2,l}w_{f,l}^{H}, where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. Moreover, O₁, O₂ oversampling factors are assumed for the 2D DFT matrix from which matrix B is drawn. Further, W₁ is common across all layers. W_{f} is an N₃×M matrix (M<N₃) with columns selected from a critically-sampled size-N₃ DFT matrix, as follows:

$${W}_{f , l} = [ \begin{matrix}{f}_{{k}_{0}} & {f}_{{k}_{1}} & … & {f}_{{k}_{{M}^{′} - 1}}\end{matrix} ] , 0 \leq {k}_{i} < {N}_{3} - 1 ,$$

$${f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T} .$$

Only the indices of the L selected columns of B are reported, along with the oversampling index taking on O₁O₂ values. Similarly, for W_{F,l}, only the indices of the M selected columns out of the predefined size-N₃ DFT matrix are reported. In the sequel the indices of the M dimensions are referred as the selected frequency domain (FD) basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, W_{f} are selected independent for different layers. Amplitude and phase values of an approximately β fraction of the 2LM available coefficients are reported to the gNB (β<1) as part of the CSI report. Coefficients with zero magnitude are indicated via a per-layer bitmap, with the strongest coefficient amplitude set to one, and an index of the strongest coefficient reported. No amplitude or phase information is explicitly reported for this coefficient. Amplitude and phase values of a maximum of ┌2βLM┐−1 coefficients, compared with 2N₁N₂×N₃-1 coefficients of a theoretical design.

In some embodiments, there may be an NR Type-II port selection codebook.

For Type-II port selection codebook, only K (where K≤2N₁N₂) beamformed CSI-RS ports are utilized in DL transmission to reduce complexity. The K×N3 codebook matrix per layer takes on the form: Wₗ=W₁^{PS}\tilde{W}_{2,l}W_{f,l}^{H}. Here, \tilde{W}_{2,l} and W_{3,l} follow the same structure as a conventional NR Type-II codebook, where both are layer specific. The matrix Wₗ^{PS} is a K×2L block-diagonal matrix with the same structure as that in an NR Type-II port selection codebook.

In various embodiments, there may be an NR Type-II port selection codebook.

For Type-II port selection codebook, there may be a similar structure to that of other port-selection codebooks, as follows: Wₗ=\tilde{W}₁^{PS}\tilde{W}_{2,l}W_{f,l}^{H}. In such embodiments, the port-selection matrix \tilde{W}₁^{PS} supports free selection of the K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉$$

are used to identify the K/2 selected ports per polarization, wherein this selection is common across all layers. Here, \tilde{W}_{2,l} and W_{f,l} follow the same structure as other NR Type-II codebooks, however M is limited to 1 and 2 only, with the network configuring a window of size N={2,4} for M=2. Moreover, the bitmap is reported unless β=1 and the UE reports all the coefficients for a rank up to a value of two.

In various embodiments, there may be codebook reporting. The codebook report is partitioned into two parts based on the priority of information reported. Each part is encoded separately (e.g., Part 1 has a possibly higher code rate). Described herein there may be parameters for NR Type-II codebook only.

In some embodiments, a content of a CSI report may include: 1) Part 1: RI+CQI+Total number of coefficients; and 2) Part 2: SD basis indicator+FD basis indicator/layer+Bitmap/layer+Coefficient Amplitude info/layer+Coefficient Phase info/layer+Strongest coefficient indicator/layer. Furthermore, Part 2 CSI may be decomposed into sub-parts each with different priority (e.g., higher priority information listed first). Such partitioning is required to allow dynamic reporting size for codebook based on available resources in the uplink phase. Also Type-II codebook is based on aperiodic CSI reporting, and only reported in PUSCH via downlink control information (DCI) triggering (e.g., one exception). Type-I codebook can be based on periodic CSI reporting (PUCCH) or semi-persistent CSI reporting (PUSCH or PUCCH) or aperiodic reporting (PUSCH).

In various embodiments, there may be priority reporting for Part 2 CSI. Multiple (e.g., up to NRep) CSI reports may be transmitted, whose priority are shown in Table 1.

TABLE 1
CSI Reports priority ordering

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
typeII-r16’ or ‘typeII-PortSelection-r16’; Part 2
subband CSI of even subbands for CSI report
N_{Rep}, if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

In various embodiments, a priority of the NRep CSI reports may be based on the following: 1) a CSI report corresponding to one CSI reporting configuration for one cell may have higher priority compared with another CSI report corresponding to one other CSI reporting configuration for the same cell; 2) CSI reports intended to one cell may have higher priority compared with other CSI reports intended to another cell; 3) CSI reports may have higher priority based on the CSI report content, e.g., CSI reports carrying layer 1 (L1)-reference signal received power (RSRP) information have higher priority; and/or 4) CSI reports may have higher priority based on their type, e.g., whether the CSI report is aperiodic, semi-persistent or periodic, and whether the report is sent via PUSCH or PUCCH, may impact the priority of the CSI report. In light of that, CSI reports may be prioritized as follows, where CSI reports with lower IDs have higher priority: Pri_{iCSI}(y, k, c, s)=2·N_{cells}·Mₛ·y+N_{cells}·Mₛ·k+Mₛ·c+s, where s: CSI reporting configuration index, and Ms: Maximum number of CSI reporting configurations, c: Cell index, and Ncells: Number of serving cells, k: 0 for CSI reports carrying L1-RSRP or L1-signal-to-interference and noise ratio (SINR), 1 otherwise, y: 0 for aperiodic reports, 1 for semi-persistent reports on PUSCH, 2 for semi-persistent reports on PUCCH, 3 for periodic reports.

In certain embodiments, there may be triggering of aperiodic CSI reporting on PUSCH. In such embodiments, a UE may need to report needed CSI information for a network using a CSI framework in NR. The triggering mechanism between a report setting and a resource setting can be summarized in Table 2.

TABLE 2
Triggering Mechanism Between a Report
Setting and a Resource Setting

| | | Periodic | Semi-Periodic | |
|---|---|---|---|---|
| | | CSI | (SP) CSI | AP CSI |
| | | reporting | reporting | Reporting |
| Time Domain | Periodic | RRC | Medium access | DCI |
| Behaviour of | CSI-RS | configured | control (MAC) | |
| Resource | | | control element | |
| Setting | | | (CE) (MAC-CE) | |
| | | | (PUCCH) | |
| | | | DCI (PUSCH) | |
| | SP CSI-RS | Not | MAC CE | DCI |
| | | Supported | (PUCCH) | |
| | | | DCI (PUSCH) | |
| | AP CSI-RS | Not | Not Supported | DCI |
| | | Supported | | |

In some embodiments, all associated resource settings for a CSI report setting may have a time domain behavior. Periodic CSI-RS and/or IM resource and CSI reports may be assumed to be present and active once configured by RRC. Aperiodic and semi-persistent CSI-RS and/or IM resources and CSI reports may need to be explicitly triggered or activated.

For aperiodic CSI-RS and/or IM resources and aperiodic CSI reports, triggering is done jointly by transmitting a DCI Format 0-1. Semi-persistent CSI-RS and/or IM resources and semi-persistent CSI reports may be independently activated.

In various embodiments, for aperiodic CSI-RS and/or IM resources and aperiodic CSI reports, triggering is done jointly by transmitting a DCI Format 0-1. The DCI Format 0_1 contains a CSI request field (e.g., 0 to 6 bits). A non-zero request field may point to a so-called aperiodic trigger state configured by RRC. An aperiodic trigger state may be defined as a list of up to 16 aperiodic CSI report settings identified by a CSI report setting ID for which the UE calculates simultaneously CSI and transmits it on the scheduled PUSCH transmission.

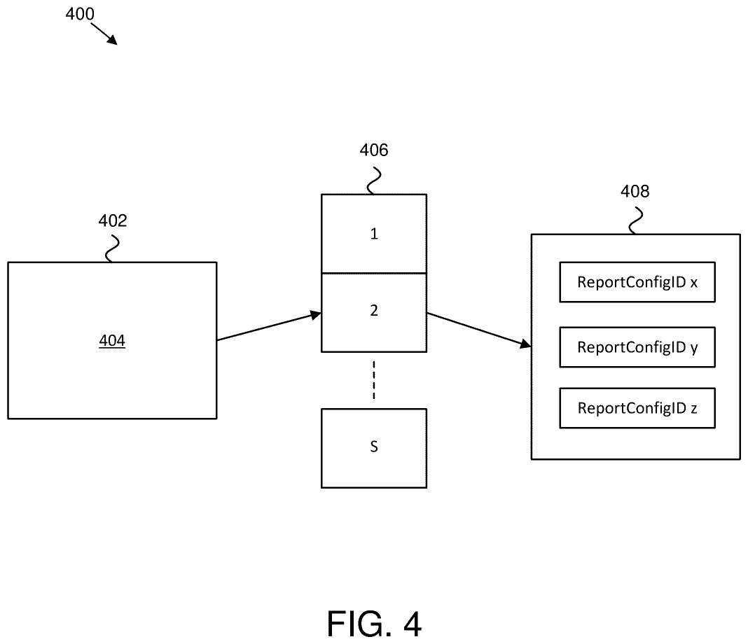

FIG. 4 illustrates an example of a flowchart 400 of an aperiodic trigger state defining a list of CSI report settings in accordance with aspects of the present disclosure. The flowchart 400 includes a DCI Format 0-1 402 including information such as a CSI request field 404 (e.g., CSI request field=2). Furthermore, a CSI request codepoint 406 is illustrated including from 1 to S. Moreover, the flowchart 400 includes an aperiodic trigger state 2 408 including report configuration IDs.

When a CSI report setting is linked with an aperiodic resource setting (e.g., can include multiple resource sets), the aperiodic NZP CSI-RS resource set for channel measurement, the aperiodic CSI-IM resource set (if used), and the aperiodic NZP CSI-RS resource set for IM (if used) to use for a given CSI report setting are also included in the aperiodic trigger state definition. For aperiodic NZP CSI-RS, a QCL source to use is also configured in the aperiodic trigger state. A UE assumes that the resources used for the computation of the channel and interference can be processed with the same spatial filter (e.g., quasi-co-located with respect to “QCL-TypeD”).

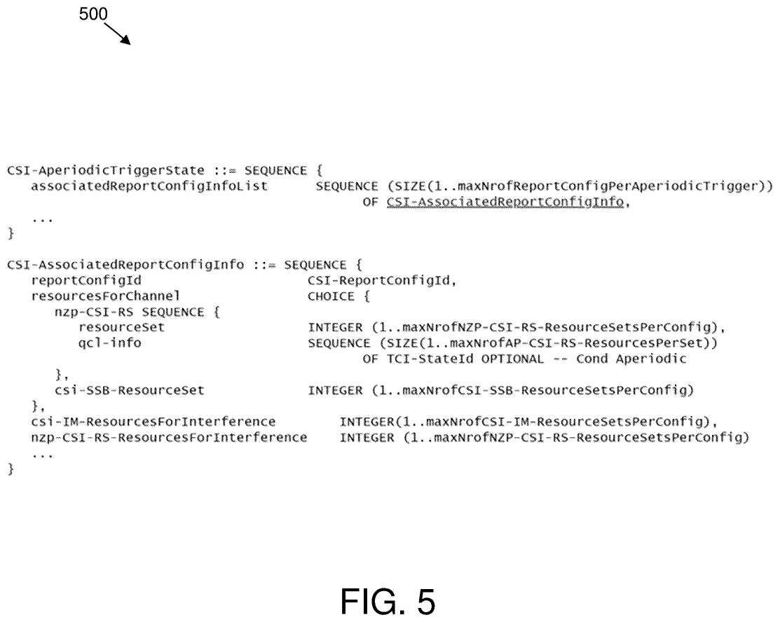

FIG. 5 illustrates an example of code 500 in which an aperiodic trigger state indicates a resource sent and QCL information in accordance with aspects of the present disclosure.

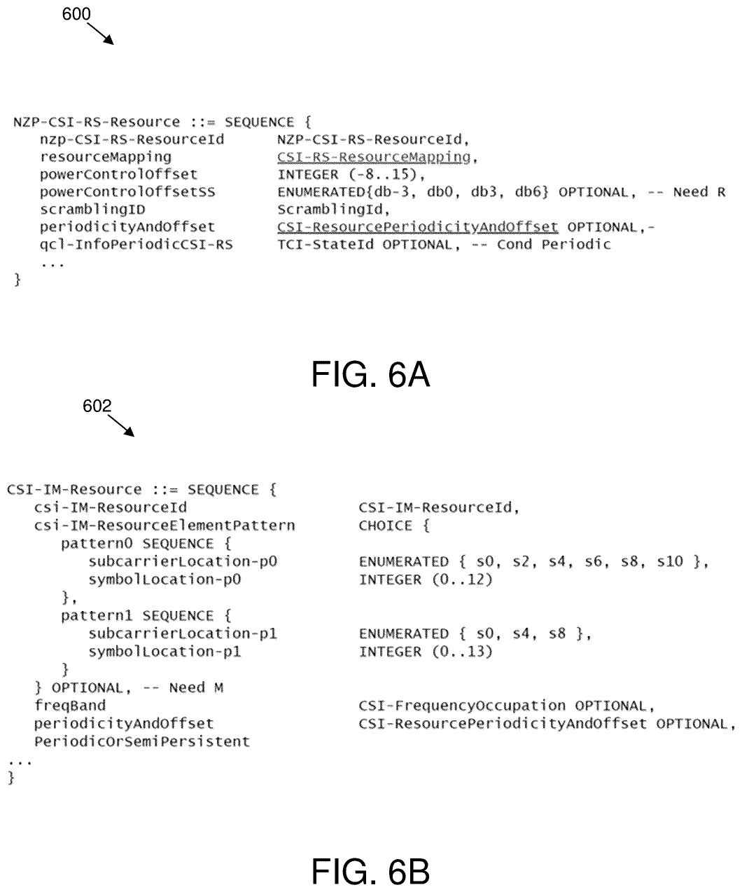

FIG. 6A illustrates an example of code 600 in which an RRC configuration includes an NZP-CSI-RS resource in accordance with aspects of the present disclosure.

FIG. 6B illustrates an example of code 602 in which an RRC configuration includes a CSI-IM resource in accordance with aspects of the present disclosure.

Table 3 summarizes a type of uplink channels used for CSI reporting as a function of the CSI codebook type.

TABLE 3
Uplink Channels Used for CSI Reporting
as a Function of the CSI Codebook Type

| | Periodic CSI | SP CSI | AP CSI |
|---|---|---|---|
| | reporting | reporting | reporting |
| Type I WB | PUCCH Format | PUCCH Format 2 | PUSCH |
| | 2, 3, 4 | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part | | PUCCH Format 3, 4 | |
| 1 only | | | |

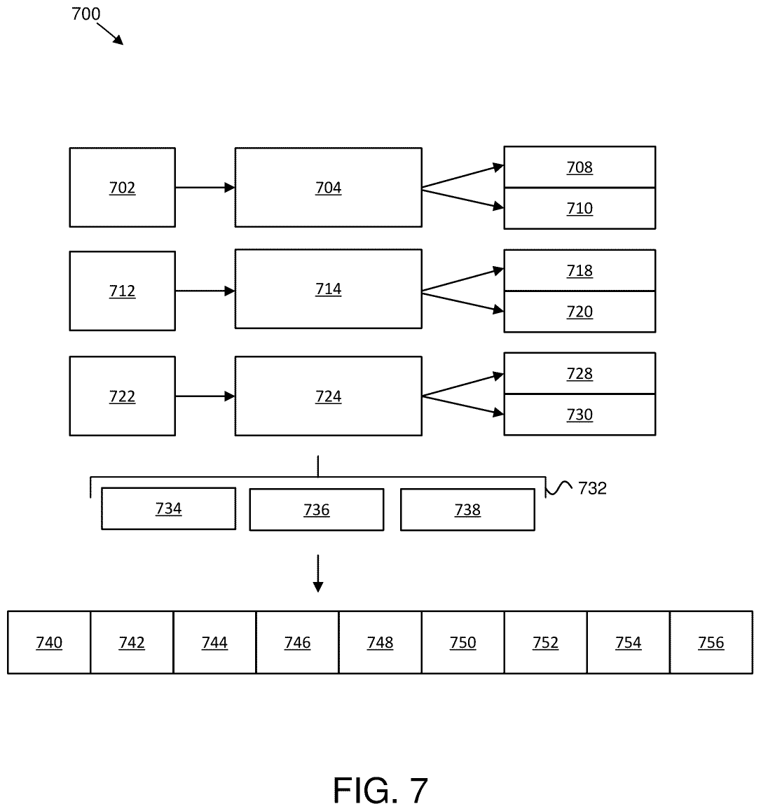

For aperiodic CSI reporting, PUSCH-based reports are divided into two CSI parts: CSI Part 1 and CSI Part 2. The reason for may be that the size of a CSI payload varies significantly, and, therefore, a worst-case uplink control information (UCI) payload size design may result in a large overhead. A CSI Part 1 has a fixed payload size (e.g., and can be decoded by the gNB without prior information) and contains the following: 1) RI (if reported), CRI (if reported), and CQI for the first codeword; and 2) a number of non-zero wideband amplitude coefficients per layer for Type II CSI feedback on PUSCH. A CSI Part 2 has a variable payload size that can be derived from the CSI parameters in CSI Part 1 and contains PMI and the CQI for the second codeword when RI>4. For example, if the aperiodic trigger state indicated by DCI format 0_1 defines 3 report settings x, y, and z, then the aperiodic CSI reporting for CSI part 2 may be ordered as indicated in FIG. 7.

FIG. 7 illustrates an example of a system 700 for partial CSI omission for PUSCH-based CSI in accordance with aspects of the present disclosure. The system 700 includes a ReportConfigID x 702 used for a Report 1 704 (e.g., requested quantities to be reported). The Report 1 704 includes a CSI part 1 708 and a CSI part 2 710. Further, the system 700 includes a ReportConfigID y 712 used for a Report 2 714 (e.g., requested quantities to be reported). The Report 2 714 includes a CSI part 1 718 and a CSI part 2 720. Moreover, the system 700 includes a ReportConfigID z 722 used for a Report 3 724 (e.g., requested quantities to be reported). The Report 3 724 includes a CSI part 1 728 and a CSI part 2 730. The CSI part 2 of the reports may be reordered 732 across reports as follows: Report 1: CSI part 2 734, Report 2: CSI part 2 736, and Report 3: CSI part 2 738. Further, the reordered 732 reports may then be used to create: Report 1 WB CSI 740, Report 2 WB CSI 742, Report 3 WB CSI 744, Report 1 Even SB CSI 746, Report 1 Odd SB CSI 748, Report 2 Even SB CSI 750, Report 2 Odd SB CSI 752, Report 3 Even SB CSI 754, and Report 3 Odd SB CSI 756.

In certain embodiments, CSI reports may be prioritized according to: 1) time-domain behavior and physical channel, where more dynamic reports are given precedence over less dynamic reports and PUSCH has precedence over PUCCH; 2) CSI content, where beam reports (e.g., L1-RSRP reporting) has priority over regular CSI reports; 3) the serving cell to which the CSI corresponds (e.g., for carrier aggregation (CA) operation), a CSI corresponding to the PCell has priority over CSI corresponding to Scells; and/or 4) the reportConfigID.

In some embodiments, there may be a CQI reporting. A CSI report may include a CQI report quantity corresponding to channel quality assuming a maximum target transport block error rates, which indicates a modulation order, a code rate, and a corresponding spectral efficiency associated with the modulation order and code rate pair. Examples of the maximum transport block error rates are 0.1 and 0.00001. The modulation order may vary from quadrature phase shift keying (QPSK) up to 1024 quadrature amplitude modulation (QAM), whereas the code rate may vary from 30/1024 up to 948/1024. One example of a CQI table for a 4-bit CQI indicator that identifies a possible CQI value with the corresponding modulation order, code rate, and efficiency is provided in Table 4.

TABLE 4
Example of a 4-bit CQI Table

| CQI | | code rate × | |
|---|---|---|---|
| index | modulation | 1024 | efficiency |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

In various embodiments, a CQI value may be reported in two formats: 1) a wideband format, wherein one CQI value is reported corresponding to each physical downlink shared channel (PDSCH) transport block; and 2) a subband format, wherein one wideband CQI value is reported for the entire transport block, in addition to a set of subband CQI values corresponding to CQI subbands on which the transport block is transmitted. CQI subband sizes are configurable, and depends on the number of physical resource blocks (PRBs) in a bandwidth part, as shown in Table 5.

TABLE 5
Configurable Subband Sizes for a
Given Bandwidth Part (BWP) Size

| Bandwidth part (PRBs) | Subband size (PRBs) |
|---|---|
| 24-72 | 4, 8 |
| 73-144 | 8, 16 |

If the higher layer parameter cqi-BitsPerSubband in a CSI reporting setting CSI-ReportConfig is configured, subband CQI values are reported in a full form, i.e., using 4 bits for each subband CQI based on a CQI table (e.g., Table 4). If the higher layer parameter cqi-BitsPerSubband in CSI-ReportConfig is not configured, for each subband s, a 2-bit sub-band differential CQI value is reported, defined as: Sub-band Offset level(s)=sub-band CQI index(s)−wideband CQI index.

The mapping from the 2-bit sub-band differential CQI values to the offset level is shown in Table 6.

TABLE 6
Mapping Subband Differential CQI Values to Offset Levels

| Sub-band differential CQI value | Offset level |
|---|---|
| 0 | 0 |
| 1 | 1 |
| 2 | ≥2 |
| 3 | ≤−1 |

In some embodiments, the terms antenna, panel, and antenna panel are used interchangeably. An antenna panel may be hardware that is used for transmitting and/or receiving radio signals at frequencies lower than 6 GHz (e.g., frequency range 1 (FR1)), or higher than 6 GHz (e.g., frequency range 2 (FR2) or millimeter wave (mmWave)). In certain embodiments, an antenna panel may include an array of antenna elements. Each antenna element may be connected to hardware, such as a phase shifter, that enables a control module to apply spatial parameters for transmission and/or reception of signals. The resulting radiation pattern may be called a beam, which may or may not be unimodal and may allow the device to amplify signals that are transmitted or received from spatial directions.

In various embodiments, an antenna panel may or may not be virtualized as an antenna port. An antenna panel may be connected to a baseband processing module through a radio frequency (RF) chain for each transmission (e.g., egress) and reception (e.g., ingress) direction. A capability of a device in terms of a number of antenna panels, their duplexing capabilities, their beamforming capabilities, and so forth, may or may not be transparent to other devices. In some embodiments, capability information may be communicated via signaling or capability information may be provided to devices without a need for signaling. If information is available to other devices the information may be used for signaling or local decision making.

In some embodiments, a device (e.g., UE, node) antenna panel may be a physical or logical antenna array including a set of antenna elements or antenna ports that share a common or a significant portion of a radio frequency (RF) chain (e.g., in-phase and/or quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (e.g., receiving or transmitting) on at least a subset of antenna elements or antenna ports active for radiating energy (e.g., active elements) of an antenna panel may require biasing or powering on of an RF chain which results in current drain or power consumption in a device associated with the antenna panel (e.g., including power amplifier and/or low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In certain embodiments, depending on a device's own implementation, a “device panel” may have at least one of the following functionalities as an operational role of unit of antenna group to control its transmit (TX) beam independently, unit of antenna group to control its transmission power independently, and/or unit of antenna group to control its transmission timing independently. The “device panel” may be transparent to a gNB. For certain conditions, a gNB or network may assume that a mapping between a device's physical antennas to the logical entity “device panel” may not be changed. For example, a condition may include until the next update or report from device or include a duration of time over which the gNB assumes there will be no change to mapping. A device may report its device capability with respect to the “device panel” to the gNB or network. The device capability may include at least the number of “device panels.” In one embodiment, a device may support UL transmission from one beam within a panel. With multiple panels, more than one beam (e.g., one beam per panel) may be used for UL transmission. In another embodiment, more than one beam per panel may be supported and/or used for UL transmission.

In some embodiments, an antenna port may be defined such that a channel over which a symbol on the antenna port is conveyed may be inferred from the channel over which another symbol on the same antenna port is conveyed.

In certain embodiments, two antenna ports are said to be QCL if large-scale properties of a channel over which a symbol on one antenna port is conveyed may be inferred from the channel over which a symbol on another antenna port is conveyed. Large-scale properties may include one or more of delay spread, Doppler spread, Doppler shift, average gain, average delay, and/or spatial receive (RX) parameters. Two antenna ports may be quasi co-located with respect to a subset of the large-scale properties and different subset of large-scale properties may be indicated by a QCL Type. For example, a qcl-Type may take one of the following values: 1) ‘QCL-TypeA’: {Doppler shift, Doppler spread, average delay, delay spread}; 2) ‘QCL-TypeB’: {Doppler shift, Doppler spread}; 3) ‘QCL-TypeC’: {Doppler shift, average delay}; and 4) ‘QCL-TypeD’: {Spatial Rx parameter}. Other QCL-Types may be defined based on combination of one or large-scale properties.

In various embodiments, spatial RX parameters may include one or more of: angle of arrival (AoA), dominant AoA, average AoA, angular spread, power angular spectrum (PAS) of AoA, average angle of departure (AoD), PAS of AoD, transmit and/or receive channel correlation, transmit and/or receive beamforming, and/or spatial channel correlation.

In certain embodiments, QCL-TypeA, QCL-TypeB, and QCL-TypeC may be applicable for all carrier frequencies, but QCL-TypeD may be applicable only in higher carrier frequencies (e.g., mmWave, FR2, and beyond), where the UE may not be able to perform omni-directional transmission (e.g., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same RX beamforming weights).

In some embodiments, an “antenna port” may be a logical port that may correspond to a beam (e.g., resulting from beamforming) or may correspond to a physical antenna on a device. In certain embodiments, a physical antenna may map directly to a single antenna port in which an antenna port corresponds to an actual physical antenna. In various embodiments, a set of physical antennas, a subset of physical antennas, an antenna set, an antenna array, or an antenna sub-array may be mapped to one or more antenna ports after applying complex weights and/or a cyclic delay to the signal on each physical antenna. The physical antenna set may have antennas from a single module or panel or from multiple modules or panels. The weights may be fixed as in an antenna virtualization scheme, such as cyclic delay diversity (CDD). A procedure used to derive antenna ports from physical antennas may be specific to a device implementation and transparent to other devices.

In certain embodiments, a transmission configuration indicator (TCI) state (TCI-state) associated with a target transmission may indicate parameters for configuring a quasi-co-location relationship between the target transmission (e.g., target RS of demodulation (DM) RS (DM-RS) ports of the target transmission during a transmission occasion) and a source reference signal (e.g., synchronization signal block (SSB), CSI-RS, and/or sounding reference signal (SRS)) with respect to quasi co-location type parameters indicated in a corresponding TCI state. The TCI describes which reference signals are used as a QCL source, and what QCL properties may be derived from each reference signal. A device may receive a configuration of a plurality of transmission configuration indicator states for a serving cell for transmissions on the serving cell. In some embodiments, a TCI state includes at least one source RS to provide a reference (e.g., UE assumption) for determining QCL and/or a spatial filter.

In some embodiments, spatial relation information associated with a target transmission may indicate a spatial setting between a target transmission and a reference RS (e.g., SSB, CSI-RS, and/or SRS). For example, a UE may transmit a target transmission with the same spatial domain filter used for receiving a reference RS (e.g., DL RS such as SSB and/or CSI-RS). In another example, a UE may transmit a target transmission with the same spatial domain transmission filter used for the transmission of a RS (e.g., UL RS such as SRS). A UE may receive a configuration of multiple spatial relation information configurations for a serving cell for transmissions on a serving cell.

In some of the embodiments described herein, a UL TCI state is provided if a device is configured with separate DL and/or UL TCI by RRC signaling. The UL TCI state may include a source reference signal which provides a reference for determining UL spatial domain transmission filter for the UL transmission (e.g., dynamic-grant/configured-grant based PUSCH, dedicated PUCCH resources) in a CC or across a set of configured CCs and/or BWPs.

In various embodiments described herein, a joint DL and/or UL TCI state is provided if the device is configured with joint DL and/or UL TCI by RRC signaling (e.g., configuration of joint TCI or separate DL and/or UL TCI is based on RRC signaling). The joint DL and/or UL TCI state refers to at least a common source reference RS used for determining both the DL QCL information and the UL spatial transmission filter. The source RS determined from the indicated joint (or common) TCI state provides QCL Type-D indication (e.g., for device-dedicated physical downlink control channel (PDCCH) and/or PDSCH) and is used to determine UL spatial transmission filter (e.g., for UE-dedicated PUSCH and/or PUCCH) for a CC or across a set of configured CCs and/or BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

As used herein, the following notions may be used interchangeably: transmit-receive point (TRP), panel, set of antennas, set of antenna ports, uniform linear array, cell, node, radio head, communication (e.g., signals and/or channels) associated with a control resource set (CORESET) pool, communication associated with a TCI state from a transmission configuration comprising at least two TCI states. Moreover, a codebook type used for PMI reporting may be arbitrary (e.g., flexibility to use different codebook types such as different versions of a Type-II codebook).

Multiple embodiments are described herein. It should be noted that one or more elements or features from one or more of the described embodiments may be combined.

In a first set of embodiments, a network energy saving mode may be activated for power-domain enhancement. As part of the network energy saving activation, a UE may be expected to receive a first signaling from a network entity corresponding to an indication of a network energy saving mode.

In a first embodiment of the first set of embodiments, the network energy saving mode is indicated via PDCCH signaling (e.g., as part of DCI transmitted to the UE). In a first example, a DCI corresponds to a DCI format for scheduling PUSCH (e.g., DCI format 0_2). In a second example, a DCI includes a parameter for activating network energy saving (e.g., one bit of a CSI request field). In a third example, a CSI request includes a CSI reporting config ID selected from a set of CSI reporting trigger lists.

In a second embodiment of the first set of embodiments, the network energy saving mode is indicated via MAC CE signaling associated with a downlink transmission.

In a third embodiment of the first set of embodiments, the network energy saving mode is indicated via an RRC parameter in a CSI reporting setting, a CSI resource setting, an NZP CSI-RS resource configuration, an NZP CSI-RS resource set configuration, or a combination thereof. In a first example, the network energy saving mode is inferred from configuring multiple power control offset values to a same NZP CSI-RS resource or NZP CSI-RS resource information element (IE). The multiple power control offset values may include a first power control offset, a second power control offset, and so forth. In a second example, the network energy saving mode is inferred from configuring one or more power control offset values in the CSI reporting setting. In a third example, the network energy saving mode is inferred from configuring one or more power control offset values in the CSI resource setting. In a fourth example, the network energy saving mode is inferred from configuring one or more power control offset values in the same NZP CSI-RS resource set or NZP CSI-RS resource set IE.

In a fourth embodiment of the first set of embodiments, the network energy saving mode is indicated via a CSI reporting trigger list associated with a CSI request field of one of the DCI formats in PDCCH, or the MAC-CE signaling, or a combination thereof. In one example, a CSI request field is associated with an aperiodic CSI reporting setting.

In a fifth embodiment of the first set of embodiments, the network energy saving mode is indicated via a signal that is received from one or more network entities in a wireless communication network. In a first example, the signal is received from one network entity of one or more network entities in a wireless communication network. In a second example, the signal is received from all network entities of the wireless communication network. In a third example, each network entity is associated with a distinct PDCCH transmission.

In a sixth embodiment of the first set of embodiments, the network energy saving mode corresponding to both power domain and spatial domain are indicated via a joint indicator signal that mutually activates both spatial domain and power domain network energy saving modes. In a first example, the power domain network energy saving mode corresponds to configuring a UE with multiple sub-configurations corresponding to multiple power control offset values. In a second example, the spatial domain network energy saving mode corresponds to configuring the UE with multiple sub-configurations corresponding to multiple sub-selections of NZP CSI-RS ports of an NZP CSI-RS resource for channel measurement.

In a second set of embodiments, there may be a CSI reporting configuration under a power-domain network energy saving mode. In such embodiments, a UE is expected to receive a second signaling corresponding to a CSI reporting setting associated with multiple sub-configurations that are linked to multiple power control offset values, the second signaling is received conditioned on receiving the first signaling corresponding to the indication of the network energy saving mode. In some embodiments, for example, when the network energy saving mode is implicitly inferred, such as from the multiple power control offset values, the first signaling corresponding to the indication of the network energy saving mode may not be present or transmitted.

In a first embodiment of a second set of embodiments, the multiple power control offset values correspond to multiple (e.g., assumed) ratios of PDSCH energy per resource element (EPRE) to NZP CSI-RS EPRE. The ratio of PDSCH EPRE to NZP CSI-RS EPRE may be any suitable value.

In a second embodiment of a second set of embodiments, each sub-configuration of the multiple sub-configurations corresponds to: 1) a subset of multiple subsets of the CSI reporting setting; 2) a subset of multiple subsets of a CSI resource setting for channel measurement associated with the CSI reporting setting; 3) a subset of multiple subsets of an NZP CSI resource set configuration associated with the CSI resource setting for channel measurement; and/or 4) a subset of multiple subsets of an NZP CSI resource configuration associated with the NZP CSI-RS resource set.

In a third embodiment of a second set of embodiments, the CSI reporting setting includes a CSI resource setting for channel measurement, the CSI resource setting for channel measurement further including an NZP CSI-RS resource set including a single NZP CSI-RS resource.

In a fourth embodiment of a second set of embodiments, all the multiple power control offset values are associated with a same sub-configuration of the CSI reporting setting.

In a third set of embodiments, a subset of power control offset values may be triggered under a network energy saving mode. Under the network energy saving mode, a UE may receive a third signaling corresponding to indicating a subset of the multiple sub-configurations based on the second signaling corresponding to a CSI reporting setting associated with multiple sub-configurations that are linked to multiple power control offset values.

In a first embodiment of the third set of embodiments, second signaling and third signaling are the same signaling. In a first example, the subset of the multiple sub-configurations includes the multiple sub-configurations. In a second example, the third signaling is not received (e.g., the second signaling plays the same role of the third signaling).

In a second embodiment of the third set of embodiments, the third signaling corresponds to: 1) a DCI format in PDCCH corresponding to scheduling a PUSCH; 2) a MAC-CE signaling transmitted within a downlink MAC protocol data unit (PDU); and/or 3) a RRC configuration signaling.

In a third embodiment of the third set of embodiments, the subset of the multiple sub-configurations includes one sub-configuration corresponding to one power control offset value.

In a fourth set of embodiments, there may be CSI report quantities associated with a network energy saving mode. In the fourth set of embodiments, the CSI reporting setting is associated with a plurality of CSI report quantities grouped into two groups of values, wherein the UE transmits a CSI report including the first group of values of the plurality of the CSI report quantities and the second group of values of the plurality of the CSI report quantities to a network entity. As used herein, a group of values may be at least two values. Moreover, the group of values may include values corresponding to CSI report quantities.

In a first embodiment of the fourth set of embodiments, the plurality of CSI report quantities includes a CSI-RS resource indicator (CRI), a RI, a PMI, a CQI, and/or a LI.

In a second embodiment of the fourth set of embodiments, a first group of values of the plurality of the CSI report quantities is common for the subset of multiple sub-configurations. In a first example, the first group of values of the plurality of the CSI report quantities includes a PMI value that is common for all sub-configurations. In a second example, the first group of values of the plurality of the CSI report quantities indicate a common spatial domain compression for all sub-configurations (e.g., W/matrix for the precoding matrix for all sub-configurations is common for all sub-configurations).

In a third embodiment of the fourth set of embodiments, each value of a second group of values of the plurality of the CSI report quantities is exclusive (e.g., only applies to) for each sub-configuration of the subset of multiple sub-configurations. In a first example, the second group of values of the plurality of the CSI report quantities includes multiple RI values. In a second example, the second group of values of the plurality of the CSI report quantities further includes multiple CQI values.

In a fourth embodiment of the fourth set of embodiments, the PMI value is associated with a largest RI value “vₘₐₓ” of the multiple RI values. In a first example, a sub-configuration k associated with an RI value “vₖ” that is smaller than the largest RI value is further associated with a subset of layers corresponding to the PMI value, and a number of the subset of layers corresponding to the PMI value is equal to the RI value vₖ, (e.g., vₖ≤vₘₐₓ). In a second example, the subset of layers corresponding to the PMI value for a sub-configuration k is the first vₖ layers of the PMI value (e.g., the vₖ layers with the smallest vₖ layer indices of the common PMI value).

In a fifth embodiment of the fourth set of embodiments, the CSI report further includes an indicator of vₖ layers associated with the RI value corresponding to sub-configuration k. In a first example, the indicator is a bitmap including vₘₐₓ bits, and a number of entries of the bitmap with a value of one is equal to vₖ corresponding to sub-configuration k. In a second example, the indicator is in a form of a combinatorial indicator value including an indication of vₖ layer indices from a set of vₘₐₓ layers, and the combinatorial indicator value takes on up to

$$( \begin{matrix}{v}_{max} \\ {v}_{k}\end{matrix} )$$

values from 0,1,2,

$$( \begin{matrix}{v}_{max} \\ {v}_{k}\end{matrix} ) - 1$$

corresponding to a selected subset of vₖ layers, from a set of vₘₐₓ layers, wherein a combinatorial function

$$( \begin{matrix}x \\ y\end{matrix} )$$

is a standard combination function.

In a sixth embodiment of the fourth set of embodiments, the first group of values of the plurality of the CSI report quantities further includes an LI value. In a first example, a layer whose index corresponds to the LI value is included in the all subsets of layers corresponding to the multiple sub-configurations. In a second example, a common LI value associated with the multiple sub-configurations is set to one, and the common LI value is not transmitted in the CSI report.

In certain embodiments, a UE is configured with distinct PMI, RI, CQI, and LI values corresponding to different sub-configurations associated with different power control offset values. In such embodiments, the CSI feedback overhead may be significantly large due to reporting all CSI report quantities for each sub-configuration separately; however, some CSI report quantities may be similar for different sub-configurations (e.g., PMI value corresponding to a subset of layers).

In some embodiments, a UE is configured with the same PMI, RI, and LI values corresponding to different sub-configurations associated with different power control offset values, whereas each sub-configuration is associated with a distinct CQI. In such embodiments, different sub-configurations associated with the different power control offset values may correspond to different RI values leading to challenges with respect to mapping the layers of the PMI to different sub-configurations with the different number of layers for each sub-configuration.

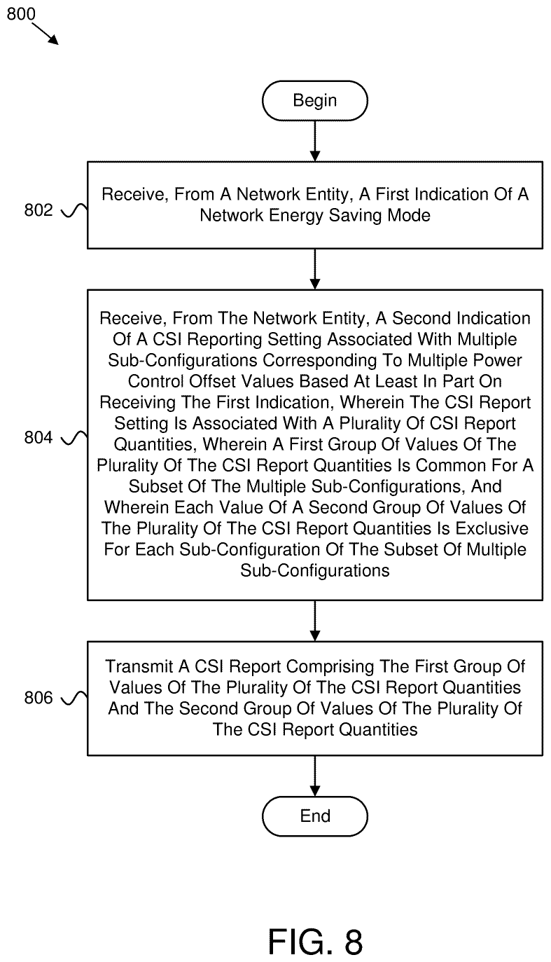

FIG. 8 illustrates a flowchart of a method 800 that supports reporting CSI in a network energy saving mode in accordance with aspects of the present disclosure. The operations of the method 800 may be implemented by an apparatus, such as a remote unit 102 or its components as described herein. For example, the operations of the method 800 may be performed by a remote unit 102 as described with reference to FIG. 1 through 7. Additionally, or alternatively, the operations of the method 800 may be performed by a processor executing program code, for example, a microcontroller, a microprocessor, a CPU, a GPU, an auxiliary processing unit, a FPGA, or the like.

In various embodiments, the method 800 includes receiving 802, from a network entity, a first indication of a network energy saving mode. In some embodiments, the method 800 includes receiving 804, from the network entity, a second indication of a CSI reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations. In certain embodiments, the method 800 includes transmitting 806 a CSI report comprising the first group of values of the plurality of the CSI report quantities and the second group of values of the plurality of the CSI report quantities.

In certain embodiments, the multiple power control offset values correspond to multiple ratios of PDSCH EPRE to NZP CSI-RS EPRE. In some embodiments, the method 800 further comprises identifying that the network energy saving mode is enabled, wherein the network energy saving mode is associated with the network entity or another network entity, or both. In various embodiments, the method 800 further comprises receiving the first indication of the network energy saving mode via a downlink control information (DCI) in physical downlink control channel (PDCCH) associated with a format scheduling a physical uplink shared channel (PUSCH), a medium access channel control element (MAC-CE), a radio resource control (RRC) configuration message, or a combination thereof.

In one embodiment, the first indication comprises an RRC configuration message indicated via a parameter of the CSI reporting setting (e.g., a CRI, a RI, a PMI, a CQI, and/or a LI), a CSI resource setting, or an NZP CSI-RS resource setting. In certain embodiments, the first indication corresponds to an aperiodic CSI reporting setting indicated in a CSI report trigger list associated with a CSI request field of the DCI, the MAC-CE, or a combination thereof. In some embodiments, each sub-configuration of the multiple sub-configurations corresponds to: a subset of multiple subsets of the CSI reporting setting; a subset of multiple subsets of a CSI resource setting for channel measurement associated with the CSI reporting setting; a subset of multiple subsets of an NZP CSI-RS resource set configuration associated with the CSI resource setting for channel measurement; a subset of multiple subsets of an NZP CSI resource configuration associated with the NZP CSI-RS resource set; or a combination thereof.

In various embodiments, the CSI reporting setting comprises a CSI resource setting for channel measurement, and the CSI resource setting for channel measurement further comprising an NZP CSI-RS resource set including a single NZP CSI-RS resource. In one embodiment, the plurality of CSI report quantities comprises a CRI, a RI, a PMI, a CQI, a LI, or a combination thereof. In certain embodiments, the first group of values of the plurality of the CSI report quantities comprises a PMI value.

In some embodiments, the second group of values of the plurality of the CSI report quantities comprises a group of RI values. In various embodiments, the PMI value is associated with a highest RI value of the group of RI values. In one embodiment, a sub-configuration associated with an RI value that is smaller than the highest RI value is further associated with a subset of layers corresponding to the PMI value, and a number of the subset of layers corresponding to the PMI value is equal to the RI value.

In certain embodiments, the subset of layers corresponding to the PMI value comprises a number of first layer identification values of the PMI value. In some embodiments, the CSI report further comprises an indicator of indices of the subset layers associated with the RI value. In various embodiments, the indicator comprises: a bitmap comprising a number of bits, and a number of entries of the bitmap with a value of one is equal to a number of the subset of layers; or a combinatorial indicator value comprising an indication of the indices of the subset of the layers from a set of layers.

In one embodiment, the first group of values of the plurality of the CSI report quantities further comprises an LI value. In certain embodiments, a layer with an index corresponding to the LI value is included in the multiple subsets of layers corresponding to the multiple sub-configurations. In some embodiments, a common LI value associated with the multiple sub-configurations is set to one, and the common LI value is not transmitted in the CSI report.

In various embodiments, the second group of values of the plurality of the CSI report quantities further comprises multiple CQI values. In one embodiment, the method 800 further comprises receiving a third indication corresponding to indicating the subset of the multiple sub-configurations based on the second indication. In certain embodiments, the second indication and the third indication are the same.

In some embodiments, the third indication comprises: a DCI corresponding to scheduling a PUSCH; a MAC-CE information; a RRC configuration information; or a combination thereof. In various embodiments, the subset of the multiple sub-configurations comprises one sub-configuration corresponding to one power control offset value.

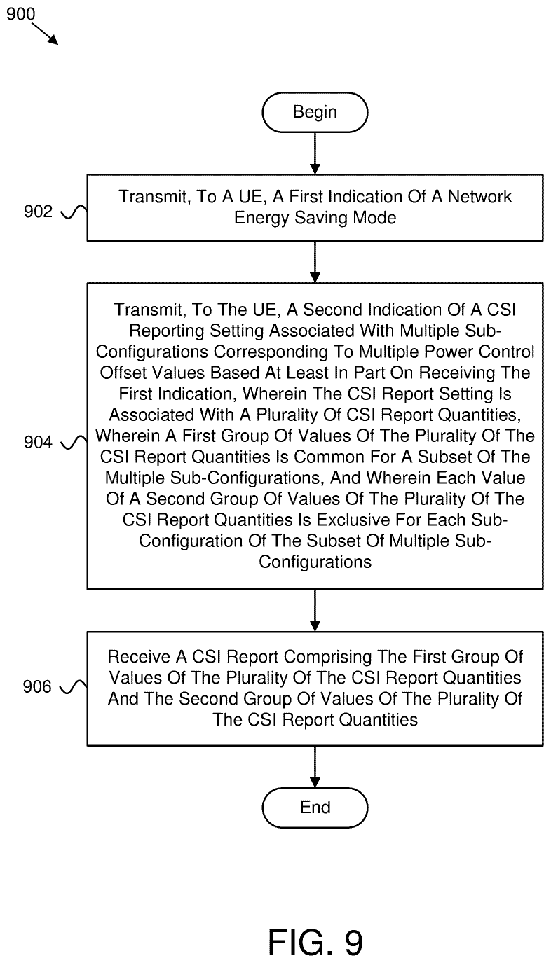

FIG. 9 is a flowchart of a method 900 that supports reporting CSI in a network energy saving mode in accordance with aspects of the present disclosure. The operations of the method 900 may be implemented by an apparatus, such as a network unit 104 or its components as described herein. For example, the operations of the method 900 may be performed by a network unit 104 as described with reference to FIG. 1 through 7. Additionally, or alternatively, the operations of the method 900 may be performed by a processor executing program code, for example, a microcontroller, a microprocessor, a CPU, a GPU, an auxiliary processing unit, a FPGA, or the like.

In various embodiments, the method 900 includes transmitting 902, to a UE, a first indication of a network energy saving mode. In some embodiments, the method 900 includes transmitting 904, to the UE, a second indication of a CSI reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations. In certain embodiments, the method 900 includes receiving 906 a CSI report comprising the first group of values of the plurality of the CSI report quantities and the second group of values of the plurality of the CSI report quantities.

In certain embodiments, the multiple power control offset values correspond to multiple ratios of PDSCH EPRE to NZP CSI-RS EPRE. In some embodiments, the method 900 further comprises identifying that the network energy saving mode is enabled, wherein the network energy saving mode is associated with the network entity or another network entity, or both. In various embodiments, the method 900 further comprises transmitting the first indication of the network energy saving mode via a downlink control information (DCI) in physical downlink control channel (PDCCH) associated with a format scheduling a physical uplink shared channel (PUSCH), a medium access channel control element (MAC-CE), a radio resource control (RRC) configuration message, or a combination thereof.

In one embodiment, the first indication comprises an RRC configuration message indicated via a parameter of the CSI reporting setting, a CSI resource setting, or an NZP CSI-RS resource setting. In certain embodiments, the first indication corresponds to an aperiodic CSI reporting setting indicated in a CSI report trigger list associated with a CSI request field of the DCI, the MAC-CE, or a combination thereof. In some embodiments, each sub-configuration of the multiple sub-configurations corresponds to: a subset of multiple subsets of the CSI reporting setting; a subset of multiple subsets of a CSI resource setting for channel measurement associated with the CSI reporting setting; a subset of multiple subsets of an NZP CSI-RS resource set configuration associated with the CSI resource setting for channel measurement; a subset of multiple subsets of an NZP CSI resource configuration associated with the NZP CSI-RS resource set; or a combination thereof.

In various embodiments, the CSI reporting setting comprises a CSI resource setting for channel measurement, and the CSI resource setting for channel measurement further comprising an NZP CSI-RS resource set including a single NZP CSI-RS resource. In one embodiment, the plurality of CSI report quantities comprises a CRI, a RI, a PMI, a CQI, a LI, or a combination thereof. In certain embodiments, the first group of values of the plurality of the CSI report quantities comprises a PMI value.

In some embodiments, the second group of values of the plurality of the CSI report quantities comprises a group of RI values. In various embodiments, the PMI value is associated with a highest RI value of the group of RI values. In one embodiment, a sub-configuration associated with an RI value that is smaller than the highest RI value is further associated with a subset of layers corresponding to the PMI value, and a number of the subset of layers corresponding to the PMI value is equal to the RI value.

In certain embodiments, the subset of layers corresponding to the PMI value comprises a number of first layer identification values of the PMI value. In some embodiments, the CSI report further comprises an indicator of indices of the subset layers associated with the RI value. In various embodiments, the indicator comprises: a bitmap comprising a number of bits, and a number of entries of the bitmap with a value of one is equal to a number of the subset of layers; or a combinatorial indicator value comprising an indication of the indices of the subset of the layers from a set of layers.

In one embodiment, the first group of values of the plurality of the CSI report quantities further comprises an LI value. In certain embodiments, a layer with an index corresponding to the LI value is included in the multiple subsets of layers corresponding to the multiple sub-configurations. In some embodiments, a common LI value associated with the multiple sub-configurations is set to one, and the common LI value is not transmitted in the CSI report.

In various embodiments, the second group of values of the plurality of the CSI report quantities further comprises multiple CQI values. In one embodiment, the method 900 further comprises transmitting a third indication corresponding to indicating the subset of the multiple sub-configurations based on the second indication. In certain embodiments, the second indication and the third indication are the same.

In some embodiments, the third indication comprises: a DCI corresponding to scheduling a PUSCH; a MAC-CE information; a RRC configuration information; or a combination thereof. In various embodiments, the subset of the multiple sub-configurations comprises one sub-configuration corresponding to one power control offset value.

In one embodiment, a method for wireless communication at a UE comprises: receiving, from a network entity, a first indication of a network energy saving mode; receiving, from the network entity, a second indication of a CSI reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations; and transmitting a CSI report comprising the first group of values of the plurality of the CSI report quantities and the second group of values of the plurality of the CSI report quantities.

In certain embodiments, the multiple power control offset values correspond to multiple ratios of PDSCH EPRE to NZP CSI-RS EPRE.

In some embodiments, the method further comprises identifying that the network energy saving mode is enabled, wherein the network energy saving mode is associated with the network entity or another network entity, or both.

In various embodiments, the method further comprises receiving the first indication of the network energy saving mode via a downlink control information (DCI) in physical downlink control channel (PDCCH) associated with a format scheduling a physical uplink shared channel (PUSCH), a medium access channel control element (MAC-CE), a radio resource control (RRC) configuration message, or a combination thereof.

In one embodiment, the first indication comprises an RRC configuration message indicated via a parameter of the CSI reporting setting, a CSI resource setting, or an NZP CSI-RS resource setting.

In certain embodiments, the first indication corresponds to an aperiodic CSI reporting setting indicated in a CSI report trigger list associated with a CSI request field of the DCI, the MAC-CE, or a combination thereof.

In some embodiments, each sub-configuration of the multiple sub-configurations corresponds to: a subset of multiple subsets of the CSI reporting setting; a subset of multiple subsets of a CSI resource setting for channel measurement associated with the CSI reporting setting; a subset of multiple subsets of an NZP CSI-RS resource set configuration associated with the CSI resource setting for channel measurement; a subset of multiple subsets of an NZP CSI resource configuration associated with the NZP CSI-RS resource set; or a combination thereof.

In various embodiments, the CSI reporting setting comprises a CSI resource setting for channel measurement, and the CSI resource setting for channel measurement further comprising an NZP CSI-RS resource set including a single NZP CSI-RS resource.

In one embodiment, the plurality of CSI report quantities comprises a CRI, a RI, a PMI, a CQI, a LI, or a combination thereof.

In certain embodiments, the first group of values of the plurality of the CSI report quantities comprises a PMI value.

In some embodiments, the second group of values of the plurality of the CSI report quantities comprises a group of RI values.

In various embodiments, the PMI value is associated with a highest RI value of the group of RI values.

In one embodiment, a sub-configuration associated with an RI value that is smaller than the highest RI value is further associated with a subset of layers corresponding to the PMI value, and a number of the subset of layers corresponding to the PMI value is equal to the RI value.

In certain embodiments, the subset of layers corresponding to the PMI value comprises a number of first layer identification values of the PMI value.

In some embodiments, the CSI report further comprises an indicator of indices of the subset layers associated with the RI value.

In various embodiments, the indicator comprises: a bitmap comprising a number of bits, and a number of entries of the bitmap with a value of one is equal to a number of the subset of layers; or a combinatorial indicator value comprising an indication of the indices of the subset of the layers from a set of layers.

In one embodiment, the first group of values of the plurality of the CSI report quantities further comprises an LI value.

In certain embodiments, a layer with an index corresponding to the LI value is included in the multiple subsets of layers corresponding to the multiple sub-configurations.

In some embodiments, a common LI value associated with the multiple sub-configurations is set to one, and the common LI value is not transmitted in the CSI report.

In various embodiments, the second group of values of the plurality of the CSI report quantities further comprises multiple CQI values.

In one embodiment, the method further comprises receiving a third indication corresponding to indicating the subset of the multiple sub-configurations based on the second indication.

In certain embodiments, the second indication and the third indication are the same.

In some embodiments, the third indication comprises: a DCI corresponding to scheduling a PUSCH; a MAC-CE information; a RRC configuration information; or a combination thereof.

In various embodiments, the subset of the multiple sub-configurations comprises one sub-configuration corresponding to one power control offset value.

In one embodiment, an apparatus for wireless communication comprises: a memory; and a processor coupled to the memory and configured to cause the apparatus to: receive, from a network entity, a first indication of a network energy saving mode; receive, from the network entity, a second indication of a channel state information (CSI) reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations; and transmit a CSI report comprising the first group of values of the plurality of the CSI report quantities and the second group of values of the plurality of the CSI report quantities.

In certain embodiments, the multiple power control offset values correspond to multiple ratios of PDSCH EPRE to NZP CSI-RS EPRE.

In some embodiments, the processor is further configured to cause the apparatus to identify that the network energy saving mode is enabled, wherein the network energy saving mode is associated with the network entity or another network entity, or both.

In various embodiments, the processor is further configured to cause the apparatus to receive the first indication of the network energy saving mode via a downlink control information (DCI) in physical downlink control channel (PDCCH) associated with a format scheduling a physical uplink shared channel (PUSCH), a medium access channel control element (MAC-CE), a radio resource control (RRC) configuration message, or a combination thereof.

In one embodiment, the first indication comprises an RRC configuration message indicated via a parameter of the CSI reporting setting, a CSI resource setting, or an NZP CSI-RS resource setting.

In certain embodiments, the first indication corresponds to an aperiodic CSI reporting setting indicated in a CSI report trigger list associated with a CSI request field of the DCI, the MAC-CE, or a combination thereof.

In some embodiments, each sub-configuration of the multiple sub-configurations corresponds to: a subset of multiple subsets of the CSI reporting setting; a subset of multiple subsets of a CSI resource setting for channel measurement associated with the CSI reporting setting; a subset of multiple subsets of an NZP CSI-RS resource set configuration associated with the CSI resource setting for channel measurement; a subset of multiple subsets of an NZP CSI resource configuration associated with the NZP CSI-RS resource set; or a combination thereof.

In various embodiments, the CSI reporting setting comprises a CSI resource setting for channel measurement, and the CSI resource setting for channel measurement further comprising an NZP CSI-RS resource set including a single NZP CSI-RS resource.

In one embodiment, the plurality of CSI report quantities comprises a CRI, a RI, a PMI, a CQI, a LI, or a combination thereof.

In certain embodiments, the first group of values of the plurality of the CSI report quantities comprises a PMI value.

In some embodiments, the second group of values of the plurality of the CSI report quantities comprises a group of RI values.

In various embodiments, the PMI value is associated with a highest RI value of the group of RI values.

In one embodiment, a sub-configuration associated with an RI value that is smaller than the highest RI value is further associated with a subset of layers corresponding to the PMI value, and a number of the subset of layers corresponding to the PMI value is equal to the RI value.

In certain embodiments, the subset of layers corresponding to the PMI value comprises a number of first layer identification values of the PMI value.

In some embodiments, the CSI report further comprises an indicator of indices of the subset layers associated with the RI value.

In various embodiments, the indicator comprises: a bitmap comprising a number of bits, and a number of entries of the bitmap with a value of one is equal to a number of the subset of layers; or a combinatorial indicator value comprising an indication of the indices of the subset of the layers from a set of layers.

In one embodiment, the first group of values of the plurality of the CSI report quantities further comprises an LI value.

In certain embodiments, a layer with an index corresponding to the LI value is included in the multiple subsets of layers corresponding to the multiple sub-configurations.

In some embodiments, a common LI value associated with the multiple sub-configurations is set to one, and the common LI value is not transmitted in the CSI report.

In various embodiments, the second group of values of the plurality of the CSI report quantities further comprises multiple CQI values.

In one embodiment, the processor is further configured to cause the apparatus to receive a third indication corresponding to indicating the subset of the multiple sub-configurations based on the second indication.

In certain embodiments, the second indication and the third indication are the same.

In some embodiments, the third indication comprises: a DCI corresponding to scheduling a PUSCH; a MAC-CE information; a RRC configuration information; or a combination thereof.

In various embodiments, the subset of the multiple sub-configurations comprises one sub-configuration corresponding to one power control offset value.

In one embodiment, a method for wireless communication at a network entity comprises: transmitting, to a UE, a first indication of a network energy saving mode; transmitting, to the UE, a second indication of a CSI reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations; and receiving a CSI report comprising the first group of values of the plurality of the CSI report quantities and the second group of values of the plurality of the CSI report quantities.

In certain embodiments, the multiple power control offset values correspond to multiple ratios of PDSCH EPRE to NZP CSI-RS EPRE.

In some embodiments, the method further comprises identifying that the network energy saving mode is enabled, wherein the network energy saving mode is associated with the network entity or another network entity, or both.

In various embodiments, the method further comprises transmitting the first indication of the network energy saving mode via a downlink control information (DCI) in physical downlink control channel (PDCCH) associated with a format scheduling a physical uplink shared channel (PUSCH), a medium access channel control element (MAC-CE), a radio resource control (RRC) configuration message, or a combination thereof.

In one embodiment, the first indication comprises an RRC configuration message indicated via a parameter of the CSI reporting setting, a CSI resource setting, or an NZP CSI-RS resource setting.

In certain embodiments, the first indication corresponds to an aperiodic CSI reporting setting indicated in a CSI report trigger list associated with a CSI request field of the DCI, the MAC-CE, or a combination thereof.

In some embodiments, each sub-configuration of the multiple sub-configurations corresponds to: a subset of multiple subsets of the CSI reporting setting; a subset of multiple subsets of a CSI resource setting for channel measurement associated with the CSI reporting setting; a subset of multiple subsets of an NZP CSI-RS resource set configuration associated with the CSI resource setting for channel measurement; a subset of multiple subsets of an NZP CSI resource configuration associated with the NZP CSI-RS resource set; or a combination thereof.

In various embodiments, the CSI reporting setting comprises a CSI resource setting for channel measurement, and the CSI resource setting for channel measurement further comprising an NZP CSI-RS resource set including a single NZP CSI-RS resource.

In one embodiment, the plurality of CSI report quantities comprises a CRI, a RI, a PMI, a CQI, a LI, or a combination thereof.

In certain embodiments, the first group of values of the plurality of the CSI report quantities comprises a PMI value.

In some embodiments, the second group of values of the plurality of the CSI report quantities comprises a group of RI values.

In various embodiments, the PMI value is associated with a highest RI value of the group of RI values.

In one embodiment, a sub-configuration associated with an RI value that is smaller than the highest RI value is further associated with a subset of layers corresponding to the PMI value, and a number of the subset of layers corresponding to the PMI value is equal to the RI value.

In certain embodiments, the subset of layers corresponding to the PMI value comprises a number of first layer identification values of the PMI value.

In some embodiments, the CSI report further comprises an indicator of indices of the subset layers associated with the RI value.

In various embodiments, the indicator comprises: a bitmap comprising a number of bits, and a number of entries of the bitmap with a value of one is equal to a number of the subset of layers; or a combinatorial indicator value comprising an indication of the indices of the subset of the layers from a set of layers.

In one embodiment, the first group of values of the plurality of the CSI report quantities further comprises an LI value.

In certain embodiments, a layer with an index corresponding to the LI value is included in the multiple subsets of layers corresponding to the multiple sub-configurations.

In some embodiments, a common LI value associated with the multiple sub-configurations is set to one, and the common LI value is not transmitted in the CSI report.

In various embodiments, the second group of values of the plurality of the CSI report quantities further comprises multiple CQI values.

In one embodiment, the method further comprises transmitting a third indication corresponding to indicating the subset of the multiple sub-configurations based on the second indication.

In certain embodiments, the second indication and the third indication are the same.

In some embodiments, the third indication comprises: a DCI corresponding to scheduling a PUSCH; a MAC-CE information; a RRC configuration information; or a combination thereof.

In various embodiments, the subset of the multiple sub-configurations comprises one sub-configuration corresponding to one power control offset value.

In one embodiment, an apparatus for wireless communication comprises: a memory; and a processor coupled to the memory and configured to cause the apparatus to: transmit, to a UE, a first indication of a network energy saving mode; transmit, to the UE, a second indication of a CSI reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations; and receive a CSI report comprising the first group of values of the plurality of the CSI report quantities and the second group of values of the plurality of the CSI report quantities.

In certain embodiments, the multiple power control offset values correspond to multiple ratios of PDSCH EPRE to NZP CSI-RS EPRE.

In some embodiments, the processor is further configured to cause the apparatus to identify that the network energy saving mode is enabled, wherein the network energy saving mode is associated with the network entity or another network entity, or both.

In various embodiments, the processor is further configured to cause the apparatus to transmit the first indication of the network energy saving mode via a downlink control information (DCI) in physical downlink control channel (PDCCH) associated with a format scheduling a physical uplink shared channel (PUSCH), a medium access channel control element (MAC-CE), a radio resource control (RRC) configuration message, or a combination thereof.

In one embodiment, the first indication comprises an RRC configuration message indicated via a parameter of the CSI reporting setting, a CSI resource setting, or an NZP CSI-RS resource setting.

In certain embodiments, the first indication corresponds to an aperiodic CSI reporting setting indicated in a CSI report trigger list associated with a CSI request field of the DCI, the MAC-CE, or a combination thereof.

In some embodiments, each sub-configuration of the multiple sub-configurations corresponds to: a subset of multiple subsets of the CSI reporting setting; a subset of multiple subsets of a CSI resource setting for channel measurement associated with the CSI reporting setting; a subset of multiple subsets of an NZP CSI-RS resource set configuration associated with the CSI resource setting for channel measurement; a subset of multiple subsets of an NZP CSI resource configuration associated with the NZP CSI-RS resource set; or a combination thereof.

In various embodiments, the CSI reporting setting comprises a CSI resource setting for channel measurement, and the CSI resource setting for channel measurement further comprising an NZP CSI-RS resource set including a single NZP CSI-RS resource.

In one embodiment, the plurality of CSI report quantities comprises a CRI, a RI, a PMI, a CQI, a LI, or a combination thereof.

In certain embodiments, the first group of values of the plurality of the CSI report quantities comprises a PMI value.

In some embodiments, the second group of values of the plurality of the CSI report quantities comprises a group of RI values.

In various embodiments, the PMI value is associated with a highest RI value of the group of RI values.

In one embodiment, a sub-configuration associated with an RI value that is smaller than the largest RI value is further associated with a subset of layers corresponding to the PMI value, and a number of the subset of layers corresponding to the PMI value is equal to the RI value.

In certain embodiments, the subset of layers corresponding to the PMI value comprises a number of first layer identification values of the PMI value.

In some embodiments, the CSI report further comprises an indicator of indices of the subset layers associated with the RI value.

In various embodiments, the indicator comprises: a bitmap comprising a number of bits, and a number of entries of the bitmap with a value of one is equal to a number of the subset of layers; or a combinatorial indicator value comprising an indication of the indices of the subset of the layers from a set of layers.

In one embodiment, the first group of values of the plurality of the CSI report quantities further comprises an LI value.

In certain embodiments, a layer with an index corresponding to the LI value is included in the multiple subsets of layers corresponding to the multiple sub-configurations.

In some embodiments, a common LI value associated with the multiple sub-configurations is set to one, and the common LI value is not transmitted in the CSI report.

In various embodiments, the second group of values of the plurality of the CSI report quantities further comprises multiple CQI values.

In one embodiment, the processor is further configured to cause the apparatus to transmit a third indication corresponding to indicating the subset of the multiple sub-configurations based on the second indication.

In certain embodiments, the second indication and the third indication are the same.

In some embodiments, the third indication comprises: a DCI corresponding to scheduling a PUSCH; a MAC-CE information; a RRC configuration information; or a combination thereof.

In various embodiments, the subset of the multiple sub-configurations comprises one sub-configuration corresponding to one power control offset value.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

1. A method for wireless communication at a user equipment (UE), the method comprising:
receiving, from a network entity, a first indication of a network energy saving mode;
receiving, from the network entity, a second indication of a channel state information (CSI) reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations; and
transmitting a CSI report comprising the first group of values of the plurality of the CSI report quantities and the second group of values of the plurality of the CSI report quantities.

2. The method of claim 1, wherein the multiple power control offset values correspond to multiple ratios of physical downlink shared channel (PDSCH) energy per resource element (EPRE) to non-zero power (NZP) CSI reference signal (CSI-RS) EPRE.

3. The method of claim 1, further comprising:
receiving the first indication of the network energy saving mode via a downlink control information (DCI) in physical downlink control channel (PDCCH) associated with a format scheduling a physical uplink shared channel (PUSCH), a medium access channel control element (MAC-CE), a radio resource control (RRC) configuration message, or a combination thereof.

4. The method of claim 3, wherein the first indication:
comprises an RRC configuration message indicated via a parameter of the CSI reporting setting, a CSI resource setting, or an NZP CSI-RS resource setting;
corresponds to an aperiodic CSI reporting setting indicated in a CSI report trigger list associated with a CSI request field of the DCI, the MAC-CE; or
a combination thereof.

5. The method of claim 1, wherein each sub-configuration of the multiple sub-configurations corresponds to:
a subset of multiple subsets of the CSI reporting setting;
a subset of multiple subsets of a CSI resource setting for channel measurement associated with the CSI reporting setting;
a subset of multiple subsets of an NZP CSI-RS resource set configuration associated with the CSI resource setting for channel measurement;
a subset of multiple subsets of an NZP CSI resource configuration associated with the NZP CSI-RS resource set; or
a combination thereof.

6. The method of claim 1, wherein the plurality of CSI report quantities comprises a CSI-RS resource indicator (CRI), a rank indicator (RI), a precoding matrix indicator (PMI), a channel quality indicator (CQI), a layer indicator (LI), or a combination thereof.

7. The method of claim 6, wherein the first group of values of the plurality of the CSI report quantities comprises a PMI value, and the second group of values of the plurality of the CSI report quantities comprises a group of RI values.

8. The method of claim 7, wherein the PMI value is associated with a highest RI value of the group of RI values.

9. The method of claim 8, wherein a sub-configuration associated with an RI value that is smaller than the highest RI value is further associated with a subset of layers corresponding to the PMI value, and a number of the subset of layers corresponding to the PMI value is equal to the RI value.

10. The method of claim 9, wherein the CSI report further comprises an indicator of indices of the subset layers associated with the RI value.

11. The method of claim 10, wherein the indicator comprises:
a bitmap comprising a number of bits, and a number of entries of the bitmap with a value of one is equal to a number of the subset of layers; or
a combinatorial indicator value comprising an indication of the indices of the subset of the layers from a set of layers.

12. The method of claim 9, wherein the first group of values of the plurality of the CSI report quantities further comprises an LI value.

13. The method of claim 12, wherein a layer with an index corresponding to the LI value is included in the multiple subsets of layers corresponding to the multiple sub-configurations.

14. The method of claim 9, wherein a common LI value associated with the multiple sub-configurations is set to one, and the common LI value is not transmitted in the CSI report.

15. The method of claim 9, wherein the second group of values of the plurality of the CSI report quantities further comprises multiple CQI values.

16. The method of claim 1, further comprising receiving a third indication corresponding to indicating the subset of the multiple sub-configurations based on the second indication.

17. The method of claim 16, wherein the third indication comprises:
a downlink control information (DCI) corresponding to scheduling a physical uplink shared channel (PUSCH);
a medium access channel control element (MAC-CE) information;
a radio resource control (RRC) configuration information; or
a combination thereof.

18. An apparatus for wireless communication, the apparatus comprising:
a memory; and
a processor coupled to the memory and configured to cause the apparatus to:
receive, from a network entity, a first indication of a network energy saving mode;
receive, from the network entity, a second indication of a channel state information (CSI) reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations; and
transmit a CSI report comprising the first group of values of the plurality of the CSI report quantities and the second group of values of the plurality of the CSI report quantities.

19. A method for wireless communication at a network entity, the method comprising:
transmitting, to a user equipment (UE), a first indication of a network energy saving mode;
transmitting, to the UE, a second indication of a channel state information (CSI) reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations; and
receiving a CSI report comprising the first group of values of the plurality of the CSI report quantities and the second group of values of the plurality of the CSI report quantities.

20. An apparatus for wireless communication, the apparatus comprising:
a memory; and
a processor coupled to the memory and configured to cause the apparatus to:
transmit, to a user equipment (UE), a first indication of a network energy saving mode;
transmit, to the UE, a second indication of a channel state information (CSI) reporting setting associated with multiple sub-configurations corresponding to multiple power control offset values based at least in part on receiving the first indication, wherein the CSI report setting is associated with a plurality of CSI report quantities, wherein a first group of values of the plurality of the CSI report quantities is common for a subset of the multiple sub-configurations, and wherein each value of a second group of values of the plurality of the CSI report quantities is exclusive for each sub-configuration of the subset of multiple sub-configurations; and
receive a CSI report comprising the first group of values of the plurality of the CSI report quantities and the second group of values of the plurality of the CSI report quantities.
